(19) United States
(12) Patent Application Publication
(10) Pub. No.: US 2026/0368463 A1
(43) Pub. Date: Nov. 19, 2026

(54) COLOR CONVERSION METHOD, COLOR CONVERSION APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventors: Mitsuhiro YAMASHITA, Matsumoto (JP); Takahiro KAMADA, Matsumoto (JP); Yuko YAMAMOTO, Shiojiri (JP); Takuya ONO, Shiojiri (JP)

(21) Appl. No.: 19/676,902

(22) Filed: May 14, 2026

(30) Foreign Application Priority Data
May 16, 2025 (JP) 2025-082289

(51) Int. Cl. G06K 15/02; H04N 1/60

(52) U.S. Cl. CPC G06K 15/1823; H04N 1/6097

(57) ABSTRACT

A color conversion method includes: receiving an input image; receiving specification of an input profile defining an association between an input value in an input color space of the input image and a color value that indicates three attribute values in an apparatus-independent color space; receiving specification of a color conversion option; converting the input value in the input color space of the input image into the color value in the apparatus-independent color space by using the input profile; and outputting, based on the color conversion option the color value converted in the converting the input value, a post-application ink amount that is an amount of ink for reproducing a color represented by the input value in the input image, by using a color prediction model that receives an amount of ink as an input and outputs spectral reflectance.

The present application is based on, and claims priority from JP Application Serial Number 2025-082289, filed May 16, 2025, the disclosure of which is hereby incorporated by reference herein in its entirety.

### BACKGROUND

### 1. Technical Field

The present disclosure relates to a color conversion method, a color conversion apparatus, and a non-transitory computer-readable storage medium storing a program.

### 2. Related Art

There is known a technique of performing printing according to user's intention by adjusting an amount of ink based on the purpose of printing. For example, in the technique described in JP-A-2009-44523, a plurality of output profiles that reproduce the same color but have different K values are prepared, an output profile that is optimal for expressing unevenness, which is texture by visual and tactile senses, is selected, and an amount of ink is determined using the selected output profile.

In the technique described in JP-A-2009-44523, an appropriate amount of ink for expressing the unevenness is merely determined, and further improvement has been required for a printing technique for reproducing the appearance of an image according to user's intention.

### SUMMARY

The present disclosure can be implemented in the following aspects.

According to a first aspect of the present disclosure, a color conversion method is provided. The color conversion method includes: receiving an input image; receiving specification of an input profile defining an association between an input value in an input color space of the input image and a color value that indicates three attribute values in an apparatus-independent color space; receiving specification of a color conversion option; converting the input value in the input color space of the input image into the color value in the apparatus-independent color space by using the input profile; and outputting, based on the color conversion option received in the receiving the specification of the color conversion option and the color value converted in the converting the input value, a post-application ink amount that is an amount of ink for reproducing a color represented by the input value in the input image and to which the color conversion option has been applied, by using a color prediction model that receives an amount of ink as an input and outputs spectral reflectance.

According to a second aspect of the present disclosure, a color conversion apparatus is provided. The color conversion apparatus includes: an input image receiving section that receives an input image; a profile acquiring section that acquires an input profile defining an association between an input value in an input color space of the input image and a color value that indicates three attribute values in an apparatus-independent color space; an option receiving section that receives specification of a color conversion option; a converting section that converts the input value in the input color space of the input image into the color value in the apparatus-independent color space by using the input profile; and an ink amount output section that outputs, based on the color conversion option received by the option receiving section and the color value converted by the converting section, a post-application ink amount that is an amount of ink for reproducing a color represented by the input value in the input image and to which the color conversion option has been applied, by using a color prediction model that receives an amount of ink as an input and outputs spectral reflectance.

According to a third aspect of the present disclosure, a non-transitory computer-readable storage medium storing a program is provided. The program causes a computer to implement: a function of receiving an input image; a function of acquiring an input profile defining an association between an input value in an input color space of the input image and a color value that indicates three attribute values in an apparatus-independent color space; a function of receiving specification of a color conversion option; a function of converting the input value in the input color space of the input image into the color value in the apparatus-independent color space by using the input profile; and a function of outputting, based on the color conversion option received and the color value converted from the input value, a post-application ink amount that is an amount of ink for reproducing a color represented by the input value in the input image and to which the color conversion option has been applied, by using a color prediction model that receives an amount of ink as an input and outputs spectral reflectance.

### BRIEF DESCRIPTION OF THE DRAWINGS

FIG. 1 is an explanatory diagram illustrating a printing system.

FIG. 2 is a flowchart illustrating a procedure of a color conversion process.

FIG. 3 is an explanatory diagram illustrating an example of an input screen.

FIG. 4 is an explanatory diagram illustrating an example of a management table for color prediction models.

FIG. 5 is the first half of a flowchart illustrating a procedure of a color conversion process.

FIG. 6 is the second half of the flowchart illustrating the procedure of the color conversion process.

FIG. 7 is an explanatory diagram illustrating some of pixels of an input image.

### DESCRIPTION OF EMBODIMENTS

### A. First Embodiment

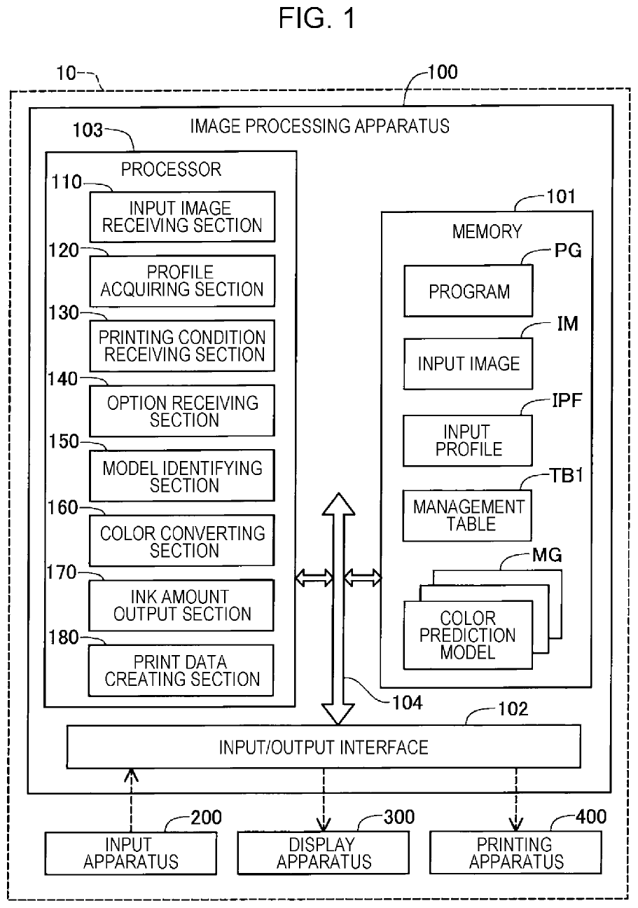

FIG. 1 is an explanatory diagram illustrating a printing system 10. The printing system 10 includes an image processing apparatus 100, an input apparatus 200, a display apparatus 300, and a printing apparatus 400.

The image processing apparatus 100 is a computer including a memory 101, an input/output interface 102, a processor 103, and an internal bus 104. The memory 101, the input/output interface 102, and the processor 103 are communicably coupled to each other via the internal bus 104. The memory 101 stores various programs and various data that are used for various processes executed by the image processing apparatus 100. The input apparatus 200, the display apparatus 300, and the printing apparatus 400 are coupled to the input/output interface 102 via wired communication or wireless communication.

The input apparatus 200 is, for example, a keyboard or a mouse. The display apparatus 300 is, for example, a liquid crystal display or an organic electro luminescence (EL) display. The input apparatus 200 and the display apparatus 300 are used to receive an operation instruction regarding printing from a user.

The printing apparatus 400 is an ink jet printing apparatus that performs printing by ejecting an ink droplet onto a printing medium. The printing medium is, for example, white paper. In the present embodiment, the printing apparatus 400 performs printing using seven colors of ink. The seven colors of ink are, for example, C, M, Y, K, Lc, Lm, and Lk. C is cyan, M is magenta, Y is yellow, and K is black. Lc is light cyan. Light cyan ink has a low cyan density. Lm is light magenta. Light magenta ink has a low magenta density. Lk is light black. Light black ink has a low black density. Lc, Lm, and Lk ink is also referred to as light ink. Spot color ink may be used for printing by the printing apparatus 400. The spot colors are orange, red, green, violet, blue, and the like.

The image processing apparatus 100 includes an input image receiving section 110, a profile acquiring section 120, a printing condition receiving section 130, an option receiving section 140, a model identifying section 150, a color converting section 160, an ink amount output section 170, and a print data creating section 180. The processor 103 implements functions of the sections by executing a program PG stored in the memory 101 in advance.

The input image receiving section 110 receives an input image IM to be printed. The input image receiving section 110 stores the received input image IM into the memory 101.

The profile acquiring section 120 receives specification of an input profile IPF and acquires the specified input profile IPF. For example, the profile acquiring section 120 acquires the input profile IPF stored in the memory 101 of the image processing apparatus 100. Alternatively, the profile acquiring section 120 may acquire the input profile IPF from a cloud server coupled to the image processing apparatus 100 via a network. In a case where the input profile IPF is embedded in the input image IM, the profile acquiring section 120 may acquire the input profile IPF embedded in the input image IM.

The input profile IPF is used for processing of color conversion from an input color space used in the input image IM to an apparatus-independent color space. The input color space is, for example, a CMYK color space or an RGB color space. The apparatus-independent color space is, for example, a CIE-L*a*b* color space or a CIE-XYZ color space. Hereinafter, the CIE-L*a*b* color space may be merely referred to as an L*a*b* color space. In the present embodiment, the input color space is the CMYK color space, and the apparatus-independent color space is the L*a*b* color space. By the color conversion using the input profile IPF, an input value representing a color in the input color space for each of pixels included in the input image IM is converted into a color value that is a value representing a color in the apparatus-independent color space for each of the pixels included in the input image IM.

The printing condition receiving section 130 receives a printing condition. As the printing condition, a printing medium and the number of passes are specified. The number of passes is the number of times a head included in the printing apparatus 400 reciprocates in order to print a predetermined printing range.

The option receiving section 140 receives specification of a color conversion option. By applying the color conversion option, intention set in an input value to convert the input value into an ink amount of an ink amount space can be reflected in the ink amount.

In the present embodiment, the user can specify the following two color conversion options.

### (1) Pure Color Preservation

In a case where the input color space is the CMYK color space, and the input value of the input color space in the input image IM indicates that any one of C, M, Y, and K is included, only ink corresponding to the color component included is used for printing in the printing apparatus 400. In the present specification, ink corresponding to the C component includes C and Lc. Ink corresponding to the M component includes M and Lm. Ink corresponding to the K component includes K, Lk, and LLk. LLk is light gray and LLk ink is black ink having a black density lower than that of light black ink. LLk is also light ink. For example, in a case where pure color preservation is specified for the C component and input values other than C among CMYK values as input values indicate zero, the amounts of the color components other than the C component, namely, the amounts of the M, Y, and K component ink, are set to zero. The same applies to pure color preservation for the M, Y, and K components. The pure color preservation for the K component is also referred to as black preservation or K preservation.

In a case where the input color space is the RGB color space, and the CMYK values converted from RGB values indicate that only any one of C, M, Y, and K is included, only ink corresponding to the color component included is used for printing in the printing apparatus 400.

### (2) Non-Input Color Removal

Ink corresponding to a color component in an amount set to zero among the CMYK values as the input values is not used for printing in the printing apparatus 400. For example, in a case where the input values are (C, M, Y, K)=(0, 50, 30, 0), C and K are zero. In this case, the amount of ink corresponding to the C component and the amount of ink corresponding to the K component are set to zero in the printing.

In a case where the input color space is the RGB color space, ink corresponding to a color component in an amount set to zero among the CMYK values converted from the RGB values is not used.

The model identifying section 150 identifies a color prediction model to be used from a color prediction model group MG in accordance with the printing condition. The color prediction model group MG is a set of color prediction models.

When an ink amount is input to the color prediction model, the color prediction model outputs predicted spectral reflectance of matter to be printed by printing with the input ink amount. As the color prediction model, for example, a neural network model as a color prediction model created by a method described in JP-A-2021-150782 disclosed by the applicant of the present disclosure can be used. The color prediction model is generated by machine learning using, as learning data, a set of amounts of ink used to print a color chart and spectral reflectance obtained by measuring a color of the printed color chart.

As described above, the printing condition includes the printing medium and the number of passes. Examples of the printing medium include matte paper, glossy photographic paper, and silk-finish photographic paper. For example, a color chart is created under a printing condition in which the printing medium is glossy photographic paper and the number of passes is 16. A plurality of color charts are created by using different printing colors. Spectral reflectance is acquired by measuring the color of each of the color charts. A color prediction model M1 is generated by machine learning using, as learning data, a set of pairs of the color charts and the spectral reflectance. Further, for example, a plurality of color charts are created under a printing condition in which the printing medium is silk-finish photographic paper and the number of passes is 8. Spectral reflectance is acquired by measuring the color of each of the color charts. A color prediction model M2 is created by machine learning using, as learning data, a set of pairs of the color charts and the spectral reflectance. By repeating the above-described processing, the plurality of color prediction models constituting the color prediction model group MG are created. The processing of preparing the plurality of color prediction models is also referred to as “preparing a plurality of color prediction models”.

The color converting section 160 converts the input value in the input color space used in the input image IM into the color value in the apparatus-independent color space by using the input profile IPF. In the present specification, three attribute values in the apparatus-independent color space are defined as the “color value”. In the present embodiment, the apparatus-independent color space is the L*a*b* color space, and the three attribute values are L* representing lightness and a* and b* representing chromaticity. The color converting section 160 is also referred to as a “converting section”.

The ink amount output section 170 outputs a post-application ink amount based on the color value converted by the color converting section 160. The post-application ink amount is an amount of ink after the color conversion option acquired using the color prediction model is applied. The processing of the ink amount output section 170 will be described in detail later.

The print data creating section 180 converts a post-application ink amount for each of the pixels into an ink dot (ink droplet) to generate print data to be supplied to the printing apparatus 400. The processor 103 implements the functions of the sections by executing the program PG stored in the memory 101 in advance.

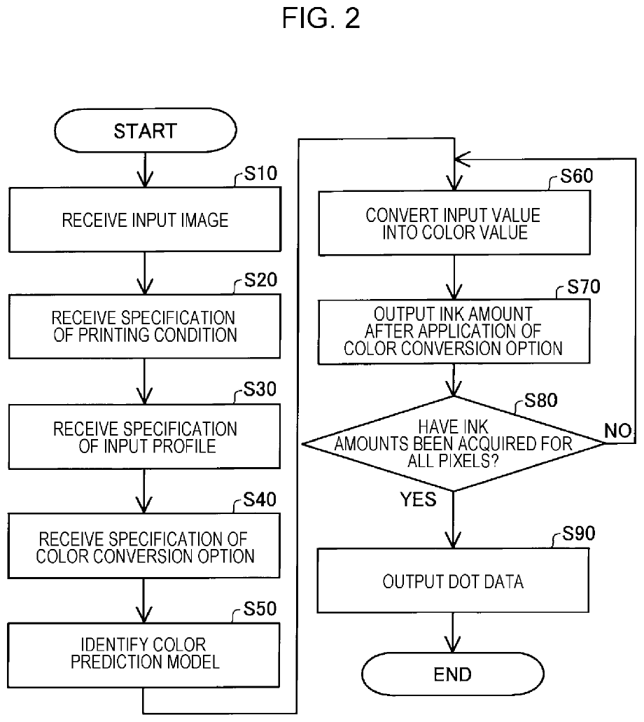

FIG. 2 is a flowchart illustrating a procedure of a color conversion process. The process illustrated in FIG. 2 is started, for example, when the user instructs the start of the process via the input apparatus 200.

In step S10, the input image receiving section 110 receives the input image IM. The input image receiving section 110 displays an input screen SC1 on the display apparatus 300. Step S10 is also referred to as “receiving an input image”.

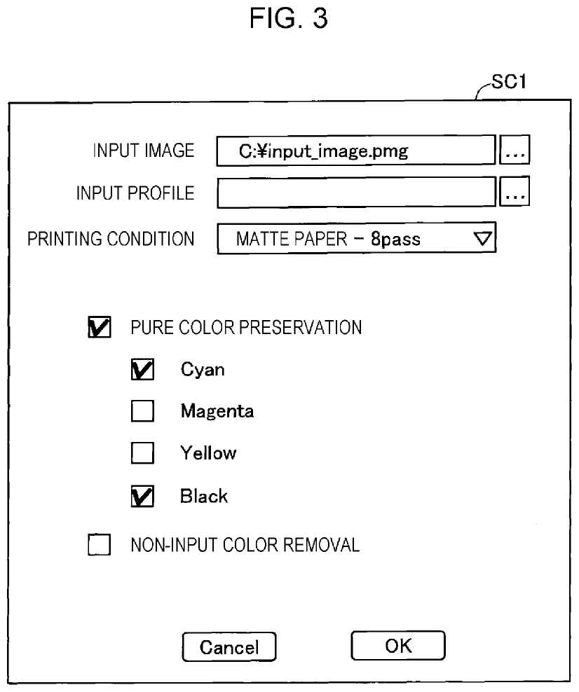

FIG. 3 is an explanatory diagram illustrating an example of the input screen SC1 as a GUI displayed on the display apparatus 300. For example, the user specifies the desired input image IM in the memory 101 of the image processing apparatus 100 using the input apparatus 200. The input image receiving section 110 reads the specified input image IM. In the present embodiment, the input color space in the input image IM is the CMYK color space.

As illustrated in FIG. 2, in step S20, the printing condition receiving section 130 receives specification of a printing condition. On the input screen SC1 illustrated in FIG. 3, the user can select any of a plurality of candidates indicating combinations of printing media and the numbers of passes. The user selects a desired combination of a printing medium and the number of passes using the input apparatus 200. The printing condition receiving section 130 records the specified combination in a predetermined region of the memory 101. Step S20 is also referred to as a “receiving specification of a printing condition”.

As illustrated in FIG. 2, in step S30, the profile acquiring section 120 receives specification of the input profile IPF. For example, the user uses the input apparatus 200 to specify a desired input profile in the memory 101 of the image processing apparatus 100. The profile acquiring section 120 reads the specified input profile IPF. In the present embodiment, since the input color space of the input image IM is the CMYK color space, it is assumed that the input profile IPF configured to set the input color space to the CMYK color space and set the apparatus-independent color space to the L*a*b* color space is specified. Step S30 is also referred to as “receiving specification of an input profile”.

In step S40, the option receiving section 140 receives specification of a color conversion option. On the input screen SC1 illustrated in FIG. 3, the user can select at least one of the pure color preservation and non-input color removal as the color conversion option. The user selects a desired color conversion option using the input apparatus 200. The user can select one or more color components among C, M, Y, and K when specifying the pure color preservation. In the illustrated example, the pure color preservation for C and K is specified. The option receiving section 140 records the specified color conversion option in a predetermined region of the memory 101. Step S40 is also referred to as “receiving specification of a color conversion option”.

As illustrated in FIG. 2, in step S50, the model identifying section 150 identifies a color prediction model to be used with reference to a management table TB1 for color prediction models. Step S50 is also referred to as “identifying a color prediction model”.

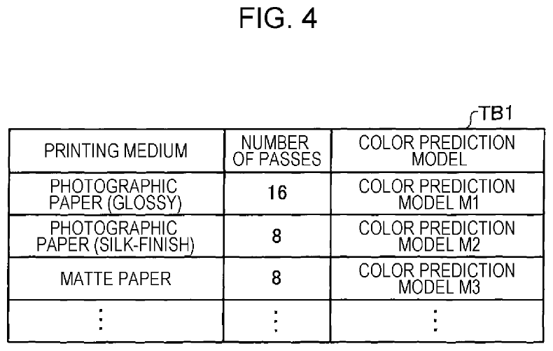

FIG. 4 is an explanatory diagram illustrating an example of the management table TB1 for the color prediction models. The management table TB1 stores information indicating an association between a printing condition indicating a printing medium and the number of passes and a color prediction model that is to be used under the specified printing condition and is included in the color prediction model group MG. In the management table TB1, a color prediction model suitable for a printing condition among the plurality of color prediction models included in the color prediction model group MG, namely, among the set of prepared color prediction models, is defined. For example, in a case where a printing condition indicates “printing medium: (glossy) photographic paper and the number of passes: 16”, a “color prediction model M1” is associated with the printing condition. This indicates that in step S20, in a case where the printing condition indicating that a printing medium is photographic paper (glossy) and the number of passes is 16 is specified, the color prediction model M1 is to be used under the specified printing condition. By using the management table TB1 for the color prediction models, it is easy to specify an appropriate color prediction model based on a printing condition among the plurality of color prediction models.

As illustrated in FIG. 2, in step S60, the color converting section 160 converts an input value in the input color space used in the input image IM into a color value in the apparatus-independent color space using the input profile IPF for one pixel included in the input image IM. The color value obtained in step S60 is a color value before the color conversion option is applied. The color value before the color conversion option is applied is also referred to as a pre-application color value. Step S60 is also referred to as “converting an input value”.

In step S70, the ink amount output section 170 outputs an ink amount that is to be used for printing the input image IM and to which the specified color conversion option has been applied. The ink amount output section 170 outputs a post-application ink amount that is the ink amount to which the color conversion option has been applied, by executing optimization processing using the color prediction model. Step S70 is also referred to as “outputting a post-application ink amount”.

In the optimization processing, a color difference that is a difference between the target color value and a color value obtained from spectral reflectance output by the color prediction model under a constraint corresponding to the specified color conversion option is minimized. The target color value is the color value obtained in step S60. This is to approximate the color value expressed by the post-application ink amount to the color value expressed by the ink amount before the application of the color conversion option. For example, the square of the difference between the target color value and the color value obtained from the spectral reflectance output by the color prediction model is set as an objective function. Note that the color value is calculated as follows based on the spectral reflectance output by the color prediction model. The spectral reflectance is converted into XYZ values in an XYZ color space according to a known calculation equation using the spectral reflectance, a CIE color matching function, and a light source spectrum of CIE standard illuminant D50. The XYZ values in the XYZ color space are converted into the color value according to a known calculation equation.

It is desirable to prepare a plurality of sets of amounts of C, M, Y, K, Lc, Lm, and Lk ink as initial values in the optimization processing. The plurality of initial values are prepared in order to reduce the risk of falling into a local solution. In addition, it is desirable that the amounts of C, M, Y, K, Lc, Lm, and Lk ink that are less than an upper limit value of a duty value of ink and satisfy the constraint corresponding to the specified color conversion option be set as the initial values. The duty value of ink represents the amount of ink to be ejected onto the medium per unit region. The range of possible duty values varies depending on the printing medium. The constraint will be described later.

A solution converges when the color difference reaches a predetermined threshold value. As described above, since the plurality of initial values are prepared, a plurality of solutions are present based on the plurality of initial values. The plurality of solutions are evaluated by a known method to determine an optimal solution. An ink amount that is an input value to a color prediction model capable of obtaining the optimal solution is set as a post-application ink amount.

### Constraint for “Pure Color Preservation”

In a case where the pure color preservation is specified, it is necessary to impose a constraint that only ink of a selected pure color is used.

In a case where the pure color preservation is applied to the C value as the input value, a constraint of (use, unuse, unuse, unuse, use, unuse, unuse) is imposed on the ink amounts (C, M, Y, K, Lc, Lm, Lk) that are inputs to the color prediction model. “Use” indicates that the ink is available. “Unuse” indicates that the ink is not available. This indicates that the values other than C and Lc among the ink amounts (C, M, Y, K, Lc, Lm, Lk) are to be set to zero. Alternatively, a constraint of (use, unuse, unuse, unuse, unuse, unuse, unuse, unuse) may be imposed on the ink amounts (C, M, Y, K, Lc, Lm, Lk) on the assumption that Lc is not included in the C component ink.

Further, the user may be able to specify a condition for using light ink and dark ink in combination via a GUI (not illustrated). For example, in a case where the C value among the CMYK values as the input values is greater than or equal to 10%, the user specifies the use of Lc ink which is light ink and the use of C ink which is dark ink. In this case where the use is specified, when the C value among the CMYK values is greater than or equal to 10%, Lc ink and C ink are used for printing. In a case where the C value among the CMYK values as the input values is less than 10%, only Lc ink is used for printing. The C component is described above as an example, but the same applies to the M component, the Y component, and the K component.

In a case where the pure color preservation is applied to the K value as the input value, a constraint of (unuse, unuse, unuse, use, unuse, unuse, use) is imposed on the ink amounts (C, M, Y, K, Lc, Lm, Lk) that are the inputs to the color prediction model. This indicates that the values other than the K and Lk values among the ink amounts (C, M, Y, K, Lc, Lm, Lk) are to be set to zero. Alternatively, a constraint of (unuse, unuse, unuse, use, unuse, unuse, unuse) may be imposed on the ink amounts (C, M, Y, K, Lc, Lm, Lk) on the assumption that Lk is not included in the K component ink. Whether the light ink is used when the option is applied is determined according to the specification of the user. The same applies to the pure color preservation for the input M and Y values.

In a case where the input color space is the RGB color space, a constraint is set as follows. First, RGB values as input values are converted into CMY values by a method described in JP-A-2024-154486 disclosed by the applicant of the present disclosure.

Ci=(1−Ri) (1)

Mi=(1−Gi) (2)

Yi=(1−Bi) (3)

In the above-described equations, Ri, Gi, and Bi are values that are obtained by normalizing the input values and are in a range from 0 to 1. Ci, Mi, and Yi are calculated by using Ri, Gi, and Bi as indicated in Equations (1), (2), and (3), respectively. Each of Ci, Mi, and Yi is a value in a range from 0 to 1. The value “1” corresponds to 100%.

The K value is calculated using Ci, Mi, and Yi.

Ki=min(Ci,Mi,Yi) (4)

In the above-described equation, min( ) is a function for selecting and outputting a minimum value.

In a case where the CMYK values converted from the RGB values indicate that only one of C, M, Y, and K is included, only ink of a color corresponding to the color component included is used for printing. Therefore, for example, in a case where the pure color preservation is applied to the C component, a constraint of (use, unuse, unuse, unuse, use, unuse, unuse) is imposed on the ink amounts (C, M, Y, K, Lc, Lm, Lk) that are the inputs to the color prediction model.

### Constraint for “Non-Input Color Removal”

In a case where the non-input color removal is specified, it is necessary to impose a constraint that ink corresponding to a color component in an amount set to zero among the input values is not used.

For example, when C=0 and K=0 among the input values, a constraint of (unuse, use, use, unuse, unuse, use, unuse) is imposed on the ink amounts (C, M, Y, K, Lc, Lm, Lk) that are the inputs to the color prediction model. This indicates that the values of the C component and the K component among the ink amounts (C, M, Y, K, Lc, Lm, Lk) are to be set to zero. Alternatively, a constraint of (unuse, use, use, unuse, use, use, use) may be imposed on the ink amounts (C, M, Y, K, Lc, Lm, and Lk) on the assumption that Lc is not included in the C component ink and Lk is not included in the K component ink. Whether the light ink is used when the option is applied is determined according to the specification of the user.

In a case where the input color space is the RGB color space, the RGB values that are the input values are converted into the CMYK values by using Equations (1) to (4) described above. A constraint is imposed that ink corresponding to a color component in an amount set to zero among the CMYK values converted from the RGB values is not used for printing in the printing apparatus 400.

### Other Constraints

In a case where at least one of the “pure color preservation” and the “non-input color removal” is specified, and in a case where none of the “pure color preservation” and the “non-input color removal” is specified, a constraint that the duty value of each ink does not exceed the upper limit value is imposed according to a specified printing medium.

As illustrated in FIG. 2, in step S80, the ink amount output section 170 determines whether ink amounts have been acquired for all the pixels of the input image IM. If the ink amount output section 170 determines that the ink amounts have not been acquired for all the pixels of the input image IM (step S80: NO), the processing in step S60 and the subsequent steps is executed again. If the ink amount output section 170 determines that the ink amounts have been acquired for all the pixels of the input image IM (step S80: YES), processing in step S90 is executed.

In step S90, the print data creating section 180 converts a post-application ink amount for each of the pixels into an ink dot (ink droplet) to generate print data to be supplied to the printing apparatus 400.

As described above, according to the present embodiment, since it is possible to output the ink amounts to which the color conversion option specified by the user has been applied, it is possible to execute printing that reproduces the appearance of the image according to the intention of the user. Further, in the present embodiment, the post-application ink amounts are obtained for the CMYK values that are the input values for all the pixels of the input image IM. For example, in a case where the processor 103 has a configuration capable of parallel calculation, it is possible to shorten the time required for calculating the ink amounts by parallel calculation, instead of sequentially calculating the ink amounts for the respective pixels. Further, in the present embodiment, since the ink amounts for the input image IM can be acquired using the input profile IPF and the color prediction model, it is not necessary to prepare an output profile and an ink amount conversion lookup table (LUT) as was required in the related art.

### B. Second Embodiment

In the first embodiment, the ink amounts to which the color conversion option has been applied are calculated for all the pixels of the input image IM. In the second embodiment, a method for improving the efficiency of the processing of calculating ink amounts is introduced. Configurations different from those in the first embodiment will be mainly described, and a description of the same configurations as those in the first embodiment will be omitted.

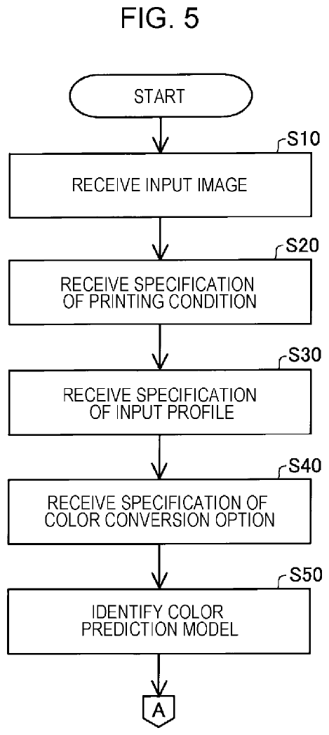

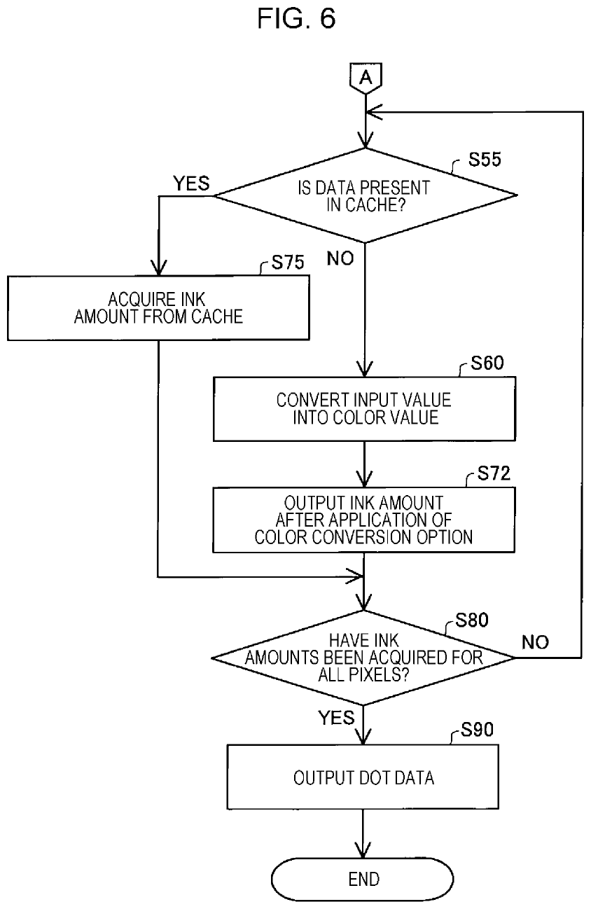

FIGS. 5 and 6 are flowcharts illustrating a procedure of a color conversion process according to the present embodiment. In FIG. 5, the same processing as that in the color conversion process described in the first embodiment is denoted by the same reference signs as those in the first embodiment. The processing in steps S10 to S50 are the same as that in the first embodiment (see FIG. 2).

As illustrated in FIG. 6, in step S55, the color converting section 160 determines whether pair data that is data of a pair of an input value in the input color space of the input image IM and a post-application ink amount is present in a cache. In the present specification, the cache is a predetermined region of the memory 101 of the image processing apparatus 100. The cache is a region for temporarily storing pair data in which an input value in the input color space of the input image IM and an already calculated post-application ink amount are associated with each other. The post-application ink amount included in the pair data is obtained from a color value based on the input value included in the pair data.

In a case where the color converting section 160 determines that a pair of each of CMYK values that are input values and a post-application ink amount is not present in the cache (step S55: NO), processing in step S60 is executed. If the color converting section 160 determines that the pair of each of the CMYK values that are the input values and the ink amount is present in the cache (step S55: YES), processing in step S75 is executed.

The processing in step S60 is the same as that in the first embodiment. In step S60, the color converting section 160 converts the input value in the input color space of the input image IM into a color value in the apparatus-independent color space by using the input profile IPF.

In step S72, the ink amount output section 170 executes optimization processing using the color prediction model and outputs the post-application ink amount.

Further, the ink amount output section 170 stores, into the cache, pair data that is data of the pair of the input value that is in the input color space of the input image IM and is determined not to be present in the cache in the immediately preceding step S55 and the post-application ink amount obtained from the color value based on the input value. Step S60 and step S72 are also referred to as “adding a pair”.

The reason why the color value based on the input value and the post-application ink amount are not paired is that the same color value may be obtained from different input values. By storing the input value in the input color space of the input image IM and the post-application ink amount as the pair, it is possible to acquire the post-application ink amount calculated for the same input value with reference to the pair data stored in the cache. The pair data has any structure. For example, the pair data may be stored in the cache as text data for each pair. The pair data may be added as a record to a table prepared in advance in the cache. At least pair data that is data of one pair stored in the cache is also referred to as “accumulated history data”. The processing in step S72 in the present embodiment is substantially the same as the processing in step S70 (see FIG. 2) in the first embodiment, but is different from the first embodiment in that the pair data is stored in the cache.

In step S75, the ink amount output section 170 acquires, from the cache, the post-application ink amount associated with each of the CMYK values that are the target input values. The processing in step S75 is executed when the color converting section 160 determines in step S55 that data of a pair of each of the CMYK values that are the input values and the ink amount is present in the cache. Step S75 is also referred to as “outputting the post-application ink amount associated with the input value”.

The processing in steps S80 and S90 is the same as that in the first embodiment.

In the first embodiment, the post-application ink amounts are calculated for the CMYK values that are the input values for all the pixels of the input image IM. On the other hand, according to the present embodiment, already calculated post-application ink amounts and corresponding input values are stored in the cache. Accordingly, in a case where a target input value is the same as an input value included in any pair data stored in the cache, a post-application ink amount included in the pair data is acquired. Therefore, a portion of the processing of calculating the post-application ink amounts can be omitted. Therefore, the efficiency of the calculation processing can be improved.

### C. Third Embodiment

In the first embodiment, the example in which the post-application ink amounts are uniformly acquired based on the input value representing the color in the input color space for each of the pixels of the input image IM has been described. Since ink amounts for adjacent pixels are not taken into consideration, smooth gradation may not be achieved on matter printed based on generated print data. Therefore, in the present embodiment, a method of calculating an ink amount in consideration of gradation will be described.

In the present embodiment, a soft constraint is introduced in optimization processing for outputting a post-application ink amount. The constraint corresponding to the color conversion option described in the first embodiment is a hard constraint. The hard constraint is a constraint that is required to be satisfied. On the other hand, the soft constraint is a constraint that is desirably satisfied as much as possible, but is not necessarily essential.

In the present embodiment, in the optimization processing for outputting a post-application ink amount, the same constraint as in the first embodiment is imposed as the hard constraint. In addition, a penalty term representing a soft constraint is added to an objective function in order to impose the soft constraint in the optimization processing.

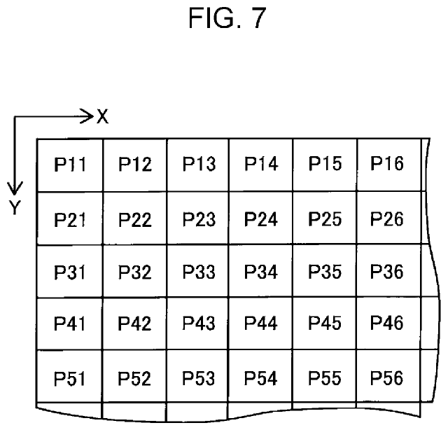

FIG. 7 is an explanatory diagram illustrating some pixels of the input image IM. A horizontal axis is an X axis and a vertical axis is a Y axis. An example of a procedure of calculating an amount of ink will be described below. An upper left pixel P11 is the first pixel for which an amount of ink is to be calculated. First, amounts of ink for pixels in the uppermost row are sequentially calculated. In the illustrated example, the amounts of ink are calculated in the order of the pixels P11, P12, P13, . . . in the X-axis direction. When the amounts of ink for all the pixels in the uppermost row are calculated, amounts of ink for pixels in the second row from the top are sequentially calculated. The amounts of ink are calculated in the order of the pixels P21, P22, P23, . . . in the X-axis direction. When the amounts of ink for all the pixels in the second row from the top are calculated, amounts of ink for pixels in the third row from the top are sequentially calculated. In the illustrated example, the amounts of ink are calculated in the order of the pixels P31, P32, P33,. . . . By repeating this processing, amounts of ink for all the pixels of the input image IM are calculated.

The soft constraint is expressed using a distance in the ink amount space between a target pixel and another pixel that is present around the target pixel and for which an amount of ink has been calculated.

In the calculation of amounts of ink in the above-described order, when amounts of ink are to be calculated for the pixel P11, a pixel for which amounts of ink have been calculated is not present around the pixel P11. Therefore, when the amounts of ink are to be calculated for the pixel P11, a penalty term representing a soft constraint is not exceptionally added to an objective function. In the present embodiment, pixels surrounding a target pixel refer to surrounding pixels adjacent to the target pixel. In this case, the surrounding pixels refer to pixels present in four directions relative to the target pixel.

When amounts of ink are to be calculated for the pixel P12, the pixel P11 for which the amounts of ink have been calculated is present around the pixel P12. Thus, a penalty term P representing a soft constraint is as follows.

P=K·SQRT(Σ(the amount of ink for the pixel P11−the amount of ink for the pixel P12)²) =K·SQRT((the amount of C ink for the pixel P11−the amount of C ink for the pixel P12)²+(the amount of M ink for the pixel P11−the amount of M ink for the pixel P12)²+(the amount of Y ink for the pixel P11−the amount of Y ink for the pixel P12)²+(the amount of K ink for the pixel P11−the amount of K ink for the pixel P12)²+(the amount of Lc ink for the pixel P11−the amount of Lc ink for the pixel P12)²+(the amount of Lm ink for the pixel P11−the amount of Lm ink for the pixel P12)²+(the amount of Lk ink for the pixel P11−the amount of Lk ink for the pixel P12)²)

In the equation, SQRT( ) indicates an operation of obtaining a square root in the parentheses. Σ indicates an operation of summing the differences between the amounts of the C, M, Y, K, Lc, Lm, and Lk ink. K is a weighting coefficient. The larger the value of K is, the more strongly the soft constraint is applied. For example, K can be set to 0.01.

When amounts of ink are to be calculated for the pixel P13, the pixel P12 for which the amounts of ink have been calculated is present around the pixel P13. Thus, a penalty term P representing a soft constraint is as follows.

P=K·SQRT(Σ(the amount of ink for the pixel P12−the amount of ink for the pixel P13)²)

When amounts of ink are to be calculated for the pixel P21, the pixel P11 for which the amounts of ink have been calculated is present around the pixel P21. Thus, a penalty term P representing a soft constraint is as follows.

P=K·SQRT(Σ(the amount of ink for the pixel P11−the amount of ink for the pixel P21)²)

When amounts of ink are to be calculated for the pixel P22, the pixels P12 and P21 for which the amounts of ink have been calculated are present around the pixel P22. Thus, a penalty term P representing a soft constraint is as follows.

P=K1·SQRT(Σ(the amount of ink for the pixel P12−the amount of ink for the pixel P22)²) +K2·SQRT(Σ(the amount of ink for the pixel P21−the amount of ink for the pixel P22)²)

In the above-described equation, K1 and K2 are weighting coefficients. Note that K1 may be equal to K2. Alternatively, when it is desired to achieve smoother gradation in the Y-axis direction than in the X-axis direction, K1 is set to be greater than K2. When it is desired to achieve smoother gradation in the X-axis direction than in the Y-axis direction, K2 can be set to be greater than K1.

A penalty term based on a distance in the ink amount space between a target pixel and a pixel that is present around the target pixel and for which amounts of ink have been calculated is added to an objective function, and the optimization processing is executed. In this way, optimization with hard and soft constraints imposed can be executed. In the present embodiment, since a distance in the ink amount space between a target pixel and another pixel that is present around the target pixel and for which amounts of ink have been calculated is taken into consideration as a soft constraint, it is possible to calculate amounts of ink while taking into consideration of gradation. Therefore, it is possible to suppress deterioration of gradation on printed matter. As described above, in the present embodiment, since ink amounts are acquired in consideration of the continuity of gradations between the pixels, the gradation of the printed image can be improved.

In the above-described method, the example in which the surrounding pixels are present in the four directions around the target pixel has been described. Alternatively, pixels surrounding the target pixel in all directions may be set as surrounding pixels. For example, in the example illustrated in FIG. 7, pixels surrounding the pixel P33 are the pixels P22, P23, P24, P32, P34, P42, P43, and P44. In a soft constraint, an amount of ink for a pixel for which an amount of ink has not been calculated among the surrounding pixels is not taken into consideration.

A pixel that is not adjacent to the target pixel may be set as a surrounding pixel. For example, in the example illustrated in FIG. 7, pixels surrounding the pixel P33 may include the pixels P13, P31, P35, and P53 in addition to the pixel P22, P23, P24, P32, P34, P42, P43, and P44. Further, it is desirable that a value of a weighting coefficient for a surrounding pixel is set to be smaller as the surrounding pixel is farther from the target pixel. In a soft constraint, an amount of ink for a pixel for which an amount of ink has not been calculated among the surrounding pixels is not taken into consideration.

In a penalty term, weighting coefficients may be different for colors of ink. An example of the penalty term P representing the soft constraint in a case where a pixel for which amounts of ink are to be calculated is the pixel P12 is as follows.

P=K_{C}·SQRT((the amount of C ink for the pixel P11−the amount of C ink for the pixel P12)²) +K_{M}·SQRT((the amount of M ink for the pixel P11−the amount of M ink for the pixel P12)²) +K_{Y}·SQRT((the amount of Y ink for the pixel P11−the amount of Y ink for the pixel P12)²) +K_{K}·SQRT((the amount of K ink for the pixel P11−the amount of K ink for the pixel P12)²) +K_{Lc}·SQRT((the amount of Lc ink for the pixel P11−the amount of Lc ink for the pixel P12)²) +K_{Lm}·SQRT((the amount of Lm ink for the pixel P11−the amount of Lm ink for the pixel P12)²) +K_{Lk}·SQRT((the amount of Lk ink for the pixel P11−the amount of Lk ink for the pixel P12)²)

By making the weighting coefficients different for the colors of ink, for example, a desire to approximate the amount of ink of a specific ink color to amounts of ink for surrounding pixels can be reflected in the soft constraint. For example, it is assumed that the amount of the K ink for the target pixel is desired to be as close as possible to the amounts of the K ink for the surrounding pixels. In this case, for example, K_{C}=K_{M}=K_{Y}=K_{Lc}=K_{Lm}=K_{Lk}=0.001, and K_{K}=1.0 can be set. By making the weighting coefficient for the K ink larger than the weighting coefficients for the other ink colors, the soft constraint is made to act most strongly on the distance for the amount of the K ink. In this case, for the amount of the K ink, the reproduction of a color value which is the basis of the calculation of the amount of the ink is prioritized over the gradation.

### D. Other Embodiments

(D1) In the first embodiment, the example has been described in which the converted ink amounts are calculated for all the pixels of the input image IM. In the second embodiment, the example has been described in which the calculation of converted ink amounts is omitted for some pixels by storing the calculated ink amounts in the cache.

In order to obtain printed matter with improved gradation, amounts of ink can also be calculated by adopting a method described in JP-A-2023-169536 disclosed by the applicant of the present disclosure. In this method, first, a gradation region in the image is identified. It is identified whether a set of pixels constituting the identified gradation region forms any of geometric shapes of a straight line, a plane, and a polyhedron in a uniform color space. Pixels on the outer edge of the geometric shape identified in the uniform color space are determined to be grid points. Amounts of ink are calculated using the color prediction model based on color values of the respective grid points. An LUT indicating associations between the color values of the grid points and the amounts of ink is created. The LUT is also referred to as an “ink conversion table”. For the pixels included in the gradation region, the amounts of ink are calculated by referring to the created LUT or by interpolation calculation using the LUT. In the interpolation calculation using the LUT, for a color value that is not defined in the LUT, an amount of ink is calculated by interpolation using an ink amount associated with a grid point around the color value in the uniform color space.

In a case where the input image IM has the gradation region, the image processing apparatus 100 can calculate an amount of ink for a pixel included in the gradation region by using the above-described method. As a result, it is possible to improve the gradation in the gradation region on the printed matter. Further, the image processing apparatus 100 can output a post-application ink amount by executing the optimization processing on a pixel included in a non-gradation region that is included in the input image IM and is not the gradation region.

(D2) The image processing apparatus 100 may cause the display apparatus 300 to display a GUI (not illustrated) to allow the user to select an item to be prioritized for the finish of printed matter. The image processing apparatus 100 uses a method of calculating an amount of ink according to the priority of the finish of specified printed matter. For example, the image processing apparatus 100 presents, to the user via a GUI, two options, an option (i) to prioritize color reproducibility and an option (ii) to prioritize gradation. Processing in which the image processing apparatus 100 presents the options and receives specification of a priority is also referred to as “receiving specification of whether to increase a priority of color reproducibility or a priority of gradation”. When the user selects the option (i) to prioritize color reproducibility, the image processing apparatus 100 can calculate an amount of ink by the method described in the first embodiment or the method described in the second embodiment. In addition, when the user selects the option (ii) to prioritize gradation, the image processing apparatus 100 can calculate an amount of ink by the method described in the other embodiment (D1).

Further, the image processing apparatus 100 may present, via a GUI (not illustrated), three options, the option (i) to prioritize color reproducibility, the option (ii) to prioritizing gradation, and an option (iii) to prioritize the efficiency of calculation as viewpoints for prioritizing the finish of printed matter. When the user selects the option (i) to prioritize color reproducibility, the image processing apparatus 100 can calculate an amount of ink by the method described in the first embodiment. When the user selects the option (ii) to prioritize gradation, the image processing apparatus 100 can calculate a color of ink by the method described in the other embodiment (D1). When the user selects the option (iii) to prioritize the efficiency of calculation, the image processing apparatus 100 can calculate an amount of ink by the method described in the second embodiment.

(D3) In the first embodiment, the example in which the printing medium and the number of passes are specified as the printing condition has been described, but the printing condition is not limited thereto. The image processing apparatus 100 may further receive, as the printing condition, a print resolution in printing by the printing apparatus 400, a model of the printing apparatus 400, and a method of halftone processing in creation of print data. Examples of the method of the halftone processing include a dither method and an error diffusion method.

(D4) The image processing apparatus 100 may use the method of calculating an amount of ink based on the gradation as described in the third embodiment in the configuration in which the pair data is stored in the cache as described in the second embodiment. In a case where pair data in which an input value in an input color space for a surrounding pixel and a post-application ink amount based on the input value are paired is stored in the cache, the image processing apparatus 100 adds a penalty term using the stored post-application ink amount to an objective function.

In the example illustrated in FIG. 7, it is assumed that an amount of ink is calculated for the pixel P22. The pixels P12 and P21 for which amounts of ink have been calculated are present around the pixel P22. An amount of ink has not yet been calculated for the pixel P23 adjacent to the pixel P22 since an amount of ink for the pixel P23 is calculated after the amount of ink is calculated for the pixel P22. For example, it is assumed that an input value in the input color space for the pixel P23 is the same as an input value in the input color space for the pixel P13. An amount of ink for the pixel P13 has already been calculated. Therefore, pair data in which the input value in the input color space for the pixel P13 and a post-application ink amount are paired is stored in the cache. The image processing apparatus 100 sets a penalty term P representing a soft constraint as follows.

P=K1·SQRT(Σ(the amount of ink for the pixel P12−the amount of ink for the pixel P22)²) +K2·SQRT(Σ(the amount of ink for the pixel P21—the amount of ink for the pixel P22)²) +K3·SQRT(Σ(the amount of ink for the pixel P23−the amount of ink for the pixel P22)²)

As the amount of ink for the pixel P23 that is included in the penalty term P, the amount of ink that is calculated for the pixel P13 and included in the pair data stored in the cache is used. As described above, since the configuration in which the pair data is stored in the cache as described in the second embodiment is adopted, it is possible to impose a soft constraint even in a case where an amount of ink for a pixel around a target pixel is not calculated.

(D5) In the third embodiment, the example in which the weighting coefficients are different for the colors of the ink has been described. For example, in a case where ink that is used by the printing apparatus 400 is C, M, Y, K, Or, and Red, it is assumed that there is a demand for frequently using a spot color. Note that orange is described as Or. In this case, the image processing apparatus 100 can set a penalty term P representing a soft constraint as follows. In the example illustrated in FIG. 7, it is assumed that a pixel for which an amount of ink is to be calculated is the pixel P12. In addition, the pixel P11 for which an amount of ink has been calculated is present around the pixel P12.

P=K1·SQRT(Σ(the amount of ink for the pixel P11−the amount of ink for the pixel P12)²) +K2·SQRT(3·(the amount of C ink for the pixel P11+the amount of M ink for the pixel P11+the amount of Y ink for the pixel P11+the amount of K ink for the pixel P11+the amount of Red ink for the pixel P11)−the amount of Or ink for the pixel P11)²

In the second term of the above-described equation, the amounts of the ink other than Or are multiplied by a coefficient “3”. The value of the penalty term is large in a case where the ink other than Or is frequently used. Therefore, optimization is executed such that Or is frequently used.

(D6) In a case where the image processing apparatus 100 acquires amounts of ink in consideration of the continuity of gradations between the pixels in the third embodiment, the continuity of gradations may not be considered for some of the pixels of the input image IM. Specifically, the image processing apparatus 100 converts the input image IM into a luminance image. The image processing apparatus 100 detects an edge by applying a Sobel filter, a Laplacian filter, or the like to the luminance image. The image processing apparatus 100 determines whether the edge strength of each of the pixel values of the pixels after the filter is applied is greater than or equal to a predetermined threshold value. The threshold value is a criterion for determining whether the edge strength of each of the pixels is high. For pixels with high edge strength, no penalty term representing a soft constraint is added to an objective function during the optimization processing. Therefore, in the optimization processing, distances between a target pixel and surrounding pixels in the ink amount space are not considered. On the other hand, in a case where a luminance value of a pixel is less than a predetermined threshold value as a result of detecting an edge of the pixel, it is determined that the strength of the edge is low. In this case, a penalty term representing a soft constraint is added to an objective function during the optimization processing for the pixel.

(D7) In the first embodiment, the example in which the color prediction model is specified with reference to the management table TB1 has been described. Alternatively, the color prediction model may be specified by a method described in JP-A-2023-175310 disclosed by the applicant of the present disclosure. In this method, the color prediction model and related information necessary for a search are registered in a database in association with each other. The related information includes the type of ink, the type of a printing medium, a printing machine, and the like used for printing the color charts used for machine learning for creating the color prediction model. The database is searched based on the related information input by the user, and the color prediction model associated with the input related information is identified.

(D8) In the first embodiment, the example in which the color prediction model group MG is stored in the memory 101 of the image processing apparatus 100 has been described. However, the color prediction model group MG may not be stored in the memory 101 of the image processing apparatus 100. The color prediction model may be obtained by a method described in JP-A-2024-000014 disclosed by the applicant of the present disclosure. In this method, the color prediction model group is stored in a server coupled to the image processing apparatus 100 via a network. The color prediction model is available to a licensed user.

(D9) In the first embodiment, the optimization processing of minimizing, under the constraint, the color difference that is the difference between the color value obtained from the spectral reflectance output by the color prediction model and the pre-application color value converted using the input profile IPF is executed (see step S70 in FIG. 2). As described above, in the first embodiment, the pre-application color value output by the color converting section 160 in step S60 is set as the target value.

Alternatively, the target value in the optimization processing may be determined as follows. First, the color converting section 160 converts an input value in the input color space of the input image IM into a color value in the apparatus-independent color space using the input profile IPF. The color value obtained by the conversion is referred to as a 1L*a*b* value. Further, the color converting section 160 converts the 1L*a*b* value into RGB values by B-to-A conversion using a color profile for the display corresponding to the display apparatus 300. Further, the RGB values are converted into a color value in the apparatus-independent color space by A-to-B conversion using the color profile for the display corresponding to the display apparatus 300. The color value obtained by the conversion is referred to as a 2L*a*b* value.

In the optimization processing in step S70, the color difference that is the difference between the 2L*a*b* value obtained by the above-described method and the color value obtained from the spectral reflectance output by the color prediction model is minimized under the constraint corresponding to the specified color conversion option. When the input image IM is displayed on the display apparatus 300, printed matter created by printing using ink in amounts obtained in this way ensures matching between the color of the image displayed on the display apparatus 300 and the color of the input image IM.

### E. Other Embodiments

The present disclosure is not limited to the embodiments described above and can be implemented in various embodiments without departing from the gist of the present disclosure. For example, the present disclosure can also be implemented in forms as follows. For example, technical features in the embodiments corresponding to technical features in each aspect described below can be replaced or combined as appropriate to solve some or all of the problems by the present disclosure or to achieve some or all of the effects of the present disclosure. In addition, unless the technical features are described as essential in the present specification, the technical features can be omitted as appropriate.

(1) According to a first aspect of the present disclosure, a color conversion method is provided. The color conversion method includes: receiving an input image; receiving specification of an input profile defining an association between an input value in an input color space of the input image and a color value that indicates three attribute values in an apparatus-independent color space; receiving specification of a color conversion option; converting the input value in the input color space of the input image into the color value in the apparatus-independent color space by using the input profile; and outputting, based on the color conversion option received in the receiving the specification of the color conversion option and the color value converted in the converting the input value, a post-application ink amount that is an amount of ink for reproducing a color represented by the input value in the input image and to which the color conversion option has been applied, by using a color prediction model that receives an amount of ink as an input and outputs spectral reflectance.

According to the aspect, since it is possible to output an amount of ink to which the color conversion option specified by a user has been applied, it is possible to execute printing which reproduces the appearance of the image according to the intention of the user.

(2) In the color conversion method according to the aspect, the color conversion option received in the receiving the specification of the color conversion option may include pure color preservation in which, in a case where the input value in the input color space indicates that only a single color component is included, only ink corresponding to the single color component is used, and non-input color removal in which an amount of ink corresponding to a color component that is not included in the input value is set to zero.

(3) The color conversion method according to the aspect may further include: preparing a plurality of color prediction models; receiving specification of a printing condition specifying at least one of a printing medium, a print resolution, and a number of passes; and identifying a color prediction model to be used in the converting the input value and the outputting the post-application ink amount from the plurality of color prediction models prepared in the preparing the plurality of color prediction models, in accordance with the printing condition received in the receiving the specification of the printing condition.

According to the aspect, the conversion of the amount of ink is executed by using the appropriate color prediction model among the plurality of color prediction models in accordance with the printing condition.

(4) In the color conversion method according to the aspect, in the outputting the post-application ink amount, for each pixel of the input image, the post-application ink amount may be output by executing optimization processing using the color prediction model based on the color value converted in the converting the input value under a constraint determined in accordance with the color conversion option received in the receiving the specification of the color conversion option.

(5) In the color conversion method according to the aspect, the outputting the post-application ink amount may include, in a case where the input value in the input color space of the input image is not included in accumulated history data, outputting the post-application ink amount by executing optimization processing using the color prediction model based on the color value converted in the converting the input value under a constraint determined in accordance with the color conversion option received in the receiving the specification of the color conversion option, and adding, to the accumulated history data, a pair of the input value and the post-application ink amount that are associated with each other, and in a case where the input value is included in the accumulated history data, outputting the post-application ink amount associated with the input value included in the accumulated history data without executing the optimization processing.

According to the aspect, by storing the already calculated post-application ink amount and the corresponding input value as the accumulated history data, the calculation of the post-application ink amount can be omitted, and the efficiency of the processing can be improved.

(6) The color conversion method according to the aspect may further include receiving specification of whether to increase a priority of color reproducibility or a priority of gradation, wherein when the specification to increase the priority of the color reproducibility is received in the receiving the specification of whether to increase the priority of the color reproducibility or the priority of the gradation, in the outputting the post-application ink amount, the adding the pair and the outputting the post-application ink amount associated with the input value are executed, and when the specification to increase the priority of the gradation is received in the receiving the specification of whether to increase the priority of the color reproducibility or the priority of the gradation, in the outputting the post-application ink amount, an ink conversion table in which an association between the color value corresponding to the input value and the post-application ink amount converted from the color value by the execution of the optimization processing is defined for a gradation region of the input image is created, the post-application ink amount is output for the gradation region by referring to the ink conversion table or by interpolation calculation using the ink conversion table, and the post-application ink amount is output for a non-gradation region of the input image by the execution of the optimization processing.

According to the aspect, it is possible to improve gradation in the gradation region.

(7) In the color conversion method according to the above aspect, in the optimization processing, a post-application ink amount is acquired for a given pixel in the input image by minimizing an objective function as a color difference that is a difference between the color value converted in the converting the input value and a color value obtained from the spectral reflectance output by the color prediction model under the constraint determined in accordance with the color conversion option received in the receiving the specification of the color conversion option, and in a case where a difference between an input value of the given pixel and an input value of a pixel adjacent to the given pixel is less than a predetermined threshold value, a post-application ink amount is acquired for the pixel adjacent to the given pixel by minimizing an objective function including a soft constraint based on a difference between the post-application ink amount for the given pixel and the post-application ink amount for the pixel adjacent to the given pixel under the constraint.

According to the aspect, since amounts of ink are acquired in consideration of the continuity of gradations between adjacent pixels, it is possible to improve the gradation of a printed image.

(8) According to a second aspect of the present disclosure, a color conversion apparatus is provided. The color conversion apparatus includes: an input image receiving section that receives an input image; a profile acquiring section that acquires an input profile defining an association between an input value in an input color space of the input image and a color value that indicates three attribute values in an apparatus-independent color space; an option receiving section that receives specification of a color conversion option; a converting section that converts the input value in the input color space of the input image into the color value in the apparatus-independent color space by using the input profile; and an ink amount output section that outputs, based on the color conversion option received by the option receiving section and the color value converted by the converting section, a post-application ink amount that is an amount of ink for reproducing a color represented by the input value in the input image and to which the color conversion option has been applied, by using a color prediction model that receives an amount of ink as an input and outputs spectral reflectance.

(9) According to a third aspect of the present disclosure, a non-transitory computer-readable storage medium storing a program is provided. The program causes a computer to implement: a function of receiving an input image; a function of acquiring an input profile defining an association between an input value in an input color space of the input image and a color value that indicates three attribute values in an apparatus-independent color space; a function of receiving specification of a color conversion option; a function of converting the input value in the input color space of the input image into the color value in the apparatus-independent color space by using the input profile; and a function of outputting, based on the color conversion option received and the color value converted from the input value, a post-application ink amount that is an amount of ink for reproducing a color represented by the input value in the input image and to which the color conversion option has been applied, by using a color prediction model that receives an amount of ink as an input and outputs spectral reflectance.

The present disclosure can also be implemented in various forms other than the color conversion method, the color conversion apparatus, and the non-transitory computer-readable storage medium storing the program. For example, the present disclosure can be implemented in the forms of an image processing method, a non-transitory storage medium storing a computer program, and the like.

What is claimed is:

1. A color conversion method comprising:
receiving an input image;
receiving specification of an input profile defining an association between an input value in an input color space of the input image and a color value that indicates three attribute values in an apparatus-independent color space;
receiving specification of a color conversion option;
converting the input value in the input color space of the input image into the color value in the apparatus-independent color space by using the input profile; and
outputting, based on the color conversion option received in the receiving the specification of the color conversion option and the color value converted in the converting the input value, a post-application ink amount that is an amount of ink for reproducing a color represented by the input value in the input image and to which the color conversion option has been applied, by using a color prediction model that receives an amount of ink as an input and outputs spectral reflectance.

2. The color conversion method according to claim 1, wherein
the color conversion option received in the receiving the specification of the color conversion option includes
pure color preservation in which, in a case where the input value in the input color space indicates that only a single color component is included, only ink corresponding to the single color component is used, and
non-input color removal in which an amount of ink corresponding to a color component that is not included in the input value is set to zero.

3. The color conversion method according to claim 2, further comprising:
preparing a plurality of color prediction models;
receiving specification of a printing condition specifying at least one of a printing medium, a print resolution, and a number of passes; and
identifying a color prediction model to be used in the converting the input value and the outputting the post-application ink amount from the plurality of color prediction models prepared in the preparing the plurality of color prediction models, in accordance with the printing condition received in the receiving the specification of the printing condition.

4. The color conversion method according to claim 3, wherein
in the outputting the post-application ink amount, for each pixel of the input image, the post-application ink amount is output by executing optimization processing using the color prediction model based on the color value converted in the converting the input value under a constraint determined in accordance with the color conversion option received in the receiving the specification of the color conversion option.

5. The color conversion method according to claim 3, wherein
the outputting the post-application ink amount includes,
in a case where the input value in the input color space of the input image is not included in accumulated history data,
outputting the post-application ink amount by executing optimization processing using the color prediction model based on the color value converted in the converting the input value under a constraint determined in accordance with the color conversion option received in the receiving the specification of the color conversion option, and
adding, to the accumulated history data, a pair of the input value and the post-application ink amount that are associated with each other, and
in a case where the input value is included in the accumulated history data,
outputting the post-application ink amount associated with the input value included in the accumulated history data without executing the optimization processing.

6. The color conversion method according to claim 5, further comprising
receiving specification of whether to increase a priority of color reproducibility or a priority of gradation, wherein
when the specification to increase the priority of the color reproducibility is received in the receiving the specification of whether to increase the priority of the color reproducibility or the priority of the gradation,
in the outputting the post-application ink amount, the adding the pair and the outputting the post-application ink amount associated with the input value are executed, and
when the specification to increase the priority of the gradation is received in the receiving the specification of whether to increase the priority of the color reproducibility or the priority of the gradation,
in the outputting the post-application ink amount,
an ink conversion table in which an association between the color value corresponding to the input value and the post-application ink amount converted from the color value by the execution of the optimization processing is defined for a gradation region of the input image is created,
the post-application ink amount is output for the gradation region by referring to the ink conversion table or by interpolation calculation using the ink conversion table, and
the post-application ink amount is output for a non-gradation region of the input image by the execution of the optimization processing.

7. The color conversion method according to claim 4, wherein
in the optimization processing,
a post-application ink amount is acquired for a given pixel in the input image by minimizing an objective function as a color difference that is a difference between the color value converted in the converting the input value and a color value obtained from the spectral reflectance output by the color prediction model under the constraint determined in accordance with the color conversion option received in the receiving the specification of the color conversion option, and
in a case where a difference between an input value of the given pixel and an input value of a pixel adjacent to the given pixel is less than a predetermined threshold value, a post-application ink amount is acquired for the pixel adjacent to the given pixel by minimizing an objective function including a soft constraint based on a difference between the post-application ink amount for the given pixel and the post-application ink amount for the pixel adjacent to the given pixel under the constraint.

8. A color conversion apparatus comprising:
an input image receiving section that receives an input image;
a profile acquiring section that acquires an input profile defining an association between an input value in an input color space of the input image and a color value that indicates three attribute values in an apparatus-independent color space;
an option receiving section that receives specification of a color conversion option;
a converting section that converts the input value in the input color space of the input image into the color value in the apparatus-independent color space by using the input profile; and
an ink amount output section that outputs, based on the color conversion option received by the option receiving section and the color value converted by the converting section, a post-application ink amount that is an amount of ink for reproducing a color represented by the input value in the input image and to which the color conversion option has been applied, by using a color prediction model that receives an amount of ink as an input and outputs spectral reflectance.

9. A non-transitory computer-readable storage medium storing a program, the program causing a computer to implement:
a function of receiving an input image;
a function of acquiring an input profile defining an association between an input value in an input color space of the input image and a color value that indicates three attribute values in an apparatus-independent color space;
a function of receiving specification of a color conversion option;
a function of converting the input value in the input color space of the input image into the color value in the apparatus-independent color space by using the input profile; and
a function of outputting, based on the color conversion option received and the color value converted from the input value, a post-application ink amount that is an amount of ink for reproducing a color represented by the input value in the input image and to which the color conversion option has been applied, by using a color prediction model that receives an amount of ink as an input and outputs spectral reflectance.
